(19) United States
(12) Patent Application Publication
(10) Pub. No.: US 2002/0140631 A1
(43) Pub. Date: Oct. 3, 2002

(54) Volumetric display unit

(76) Inventor: Barry George Blundell, La Marche (FR)

Correspondence Address: William T. Ellis, FOLEY & LARDNER, Washington Harbour, 3000 K Street, N.W, Suite 500, Washington, DC, 20007-5109, US

(21) Appl. No.: 09/789,527

(22) Filed: Feb. 22, 2001

(51) Int. Cl. G09G 5/00

(52) U.S. Cl. 345/4

(57) ABSTRACT

A volumetric display system in which a plurality of modulated beams are projected onto a moving screen to generate an image in three dimensional space. In a first embodiment beams (6) from stationary beam sources (5) are projected onto a moving screen (1). In a second embodiment beam sources (5) are moved whilst screen (1) is moved. Screen (1) is preferably a helix which is rotated and beam sources (5) are preferably rotated about a common axis of rotation. In a third embodiment a screen (21) may be reciprocated whilst an array of beam sources (22) is rotated with respect to the screen (21).

### TECHNICAL FIELD

This invention relates to the improvement of swept volume volumetric display units in which the movement of a screen is employed in association with a plurality of beam sources.

### BACKGROUND ART

A volumetric display system is characterised by possessing a transparent physical volume within which visible light may be generated, absorbed or scattered from a set of localised and specified locations. Each of these locations corresponds to a voxel—this being the generalisation of the pixel encountered upon conventional computer display systems. The voxel therefore forms the fundamental particle from which three dimensional (3-D) image components may be formed within the physical volume. This volume will be referred to as an image space and since image components may span its three physical dimensions a number of depth cues are automatically satisfied and so the three dimensionality of an image scene is naturally perceived. Volumetric systems permit images to be viewed directly and depending upon the manner in which the image space is formed may impose very little restriction upon viewing freedom. Consequently images may be viewed simultaneously by a number of observers: each observer having considerable freedom in viewing position. Architectures with this characteristic are the subject of this patent.

The terminology employed in this patent is drawn from a standard text delineating volumetric system theory and implementation [reference is made to “Volumetric Three Dimensional Display Systems” by Barry Blundell and Adam Schwartz published by John Wiley & Sons, Inc ISBN 0-471-23928-3] and is briefly introduced below. Subsequently, the current status of a particular class of volumetric display system which employs the rapid rotational motion of a helical screen for image space creation is discussed by way of example. The invention described in this document is intended to overcome problems which have to date been associated with displays of this general type, i.e. systems in which the image space is formed by the rotational motion of a non planar surface.

A display unit is the physical device which, through the application of appropriate data (this may be passed in an electrical or non-electrical form) is able to give rise to visible image sequences and contains the image space within which they are cast. Three necessary and inter-dependent sub-systems may be identified and appropriately combined so as to form the display unit. These sub-systems are referred to as the image space creation sub-system, the voxel generation sub-system and the voxel activation sub-system. Referring to each of these in turn:

The image space creation sub-system is responsible for the production of an optically transparent physical volume within which image components may be positioned and possibly manipulated. Two broad approaches may be adopted in the implementation of this volume. In one case, the rapid and cyclic motion of a target surface (screen) may produce the image space. Display units of this type are referred to as swept volume systems. Alternatively, the image space may be defined by the extent of a static material or arrangement of materials. Display units of this type in which no reliance is placed upon mechanical motion for image space creation are referred to a static volume systems. Improvements to a certain class of swept volume display unit which employs the rapid rotational motion of a screen which is non-planar in form are the subject of this patent. Consequently, static volume systems need not be considered further.

The voxel generation sub-system denotes the underlying physical process by which optical changes are produced at locations within an image space and by means of which visible voxels are produced. Examples of processes which have been applied to the production of voxels include cathodoluminescence (for example U.S. Pat. No. 5,703,606) and the scattering of visible light (for example U.S. Pat. No. 5,854,613). This patent concerns voxels which are characterised by two states—active and passive. When in the passive state the voxel is not visible and is only discernible when stimulated into an active (emissive) state. The time required to turn a voxel from its passive to active states is referred to as the voxel time (Tᵥ).

The voxel activation subsystem provides the stimulus to the voxel generation subsystems and is responsible for driving the passive to active transition of each voxel. This patent concerns display units which employ a number of directed beam sources for voxel activation. Under suitable computer control, these beam sources impinge upon the surface of a rapidly rotating non planar screen and so give rise to the emission of visible light. By rapidly modulating (100% modulation) the beam sources and arranging for rapid passive to active and active to passive transitions of the voxel generation subsystem, voxels of acceptably small size can be produced at defined locations within the image space.

In the case of a volumetric system which employs the rotational motion of a screen, the frequency of its rotation (f) should typically be equal to or in excess of the flicker fusion frequency (≈25 Hz). The inventor acknowledges that certain screen configurations which symmetrically span the axis of rotation permit voxels to be updated twice per rotation. In this case f may be one half of the flicker fusion frequency. Display units of this type may also be improved by the methods recorded in this patent. During a single rotation of the screen, an image frame may be output and by appropriately sequencing frames, image animation may be supported. The total number of voxels which may be output during an image frame is referred to as the voxel activation capacity (Nₐ). Since the production of each voxel occupies a finite time (the voxel time referred to above) the voxel activation capacity may be expressed by

$${N}_{a} = \frac{P}{{T}_{v} f} \qquad ( 1 )$$

where P denotes the number of voxels which may be activated simultaneously (display unit parallelism). Increases in the voxel activation capacity (which are desirable in order to permit the production of images which show greater detail and ensure image predictability (this will be discussed shortly) may, in principle, be achieved by (a) reducing the frequency of rotation of the screen, (b) reducing the voxel time, (c) introducing display unit parallelism. Unfortunately, any reduction in the frequency of rotation of the screen below the flicker fusion frequency will result in unaccepable levels of image flicker (other than in the case of the symmetrical screen referred to previously which allows operation at a slower rotational speed). In the case of a display unit which uses one or more directed beam sources to stimulate voxel activation, a dot graphics technique is generally employed. In this case each beam source moves between locations at which voxels are to be activated. The voxel time may consequently be expressed by:

Tᵥ=Tₘ+Tₒₙ+T_{d}+T_{off} (2)

where Tₘ denotes the time required to move between available voxel sites, Tₒₙ the time required to turn the beam source on, T_{d} the duration for which the beam must dwell on a location in order to stimulate the voxel generation process and achieve a sufficient level of voxel brightness, and T_{off} the time required to turn off the beam source. Reduction in the voxel time will generally result in a reduction in the overall image intensity which is clearly undesirable and may make it impossible to clearly discern an image under ambient lighting conditions.

As a consequence, significant increases in the voxel activation capacity may only be achieved by increasing the parallelism supported by the voxel activation/voxel generation subsystems.

The use of displays employing the rotation of a helix are advantageous in four respects. Firstly, the image space created by this method is (with the exception of the physical volume instantaneously occupied by the helical screen) of the same refractive index as the surrounding space. Consequently (although we acknowledge that the helix will generally be contained in a cylindrical structure) refraction and attenuation of light emitted from each active voxel site is minimal. Furthermore, the helical screen has considerable mechanical rigidity. The screen thickness can therefore be minimised without unaccepable flexing and hence refraction of light as it passes through the screen will be less than that which would occur in the case of other rotating screen geometries. The third advantageous characteristic associated with the helical screen structure is also linked to the inherent mechanical rigidity of the screen. This permits the width (denoted by the distance from the axis of rotation of the screen to the periphery of the image space volume) to be greater than could be achieved should other screen geometries be employed. Helical based systems are in fact particularly useful in providing a large cylindrical shaped image space in which the height to width ratio is small. The fourth advantageous characteristic of image spaces created by the motion of a helical screen relates to voxel activation on the screen itself. As with all volumetric display units which employ rotational motion for image space creation, the screen may be passive or active. In the case of a passive screen, voxel generation is determined by the form of treatment or coating applied to the surface and voxel activation is achieved by one or more directed beam sources (for example U.S. Pat. No. 5,854,613). An active approach necessitates that a large number of opto-electronic devices be bonded to the screen. These may for example take the form of light emitting diodes. In this case, since a large number of devices are required (together with associated connections), their presence will increase the mass of the rotating structure. Furthermore, they will interfere with (and possibly obstruct) light emitted in certain directions. As a consequence, it appears that no active surface helical structures have been developed to date. The majority of work undertaken to date on swept volume systems employing non-planar screens has concerned systems employing the rotational motion of helical screens and using a passive voxel generation technique together with one or more angularly deflected beam sources for voxel activation. In order to produce a cylindrical image space with a vertical central axis, the rotational axis of the helix must naturally also be vertical. Consequently the directed beam sources may be passed into the volume from below or above. This denotes the fourth advantage of a helical screen as it permits an observer to move around the cylindrical volume unhindered by the presence of any beam source/deflection apparatus.

Unfortunately, display units proposed to date which employ a helical screen geometry for image space creation and one or more directed beam sources for voxel activation (a passive voxel generation technique is inherent in this case) have a number of disadvantageous characteristics.

In order to permit the depiction of image detail (reflected by high density voxel clusters) we wish to achieve the highest possible voxel activation capacity. Increases in voxel activation capacity are also desirable when the temporal coupling of the three display unit subsystems is considered. During a single rotation of the helical screen it passes through the entirety of the image space (and so defines the extent of the volume within which image components may be located). However, as indicated in equation (2) the activation of each voxel occupies a finite time. Consider therefore two locations within the image space at which voxel activation is to occur (during a single rotation of the helical structure) and whose Cartesian coordinates are simultaneously coincident with the instantaneous position of the helix. Should the parallelism supported by the display unit be unity, then only one of these two voxels can be activated at the required location, the second will be subjected to a positioning error determined by the angular velocity of the helix, the voxel time and the radial distance of the voxel from the rotational axis. In the more general case in which an arbitrary number of voxels lie upon the instantaneous position of the helical screen, the problem is exacerbated and voxels may be significantly displaced from their required location. Consequently, we must conclude that the demand for a high voxel activation capacity (in order to create dense clusters of voxels) and the need to ensure that voxels are not shifted due to the temporal coupling of the display unit subsystems require that a plurality of beam sources be employed for voxel activation. As the number of beam sources is increased, proportional improvements are obtained in the voxel activation capacity and the number of voxels shifted as a consequence of temporal subsystem coupling is reduced.

Beam addressed systems employing the rotational motion of a helical (or approximately helical) screen have employed either angularly deflected electron (for example U.S. Pat. No. 5,703,606) or laser (U.S. Pat. No. 5,854,613) beams. In the case of electron beam(s), the image space dimensions are restricted by limitations in beam deflection apparatus and the requirement that the beam sources, deflection apparatus and screen be contained within an evacuated vessel. Consequently the majority of work has focused upon the use of angularly deflected laser beams. The stringent alignment required between the beam source deflection apparatus and the image space co-ordinate system has limited the number of beam sources which could be simultaneously employed (typically 3-4). Furthermore, in order to minimise the voxel time (and so improve the voxel activation capacity) acousto-optic scanners have generally been employed for beam deflection. Scanners of this type produce only small deflection angles and so the optical path length between scanner and the helical surface must be increased in order to permit helices of a useful size to be addressed. This has resulted in bulky volumetric systems and has given rise to portability problems. Alternatively, it has necessitated the use of additional optical components.

Finally we introduce a fill factor Ψ which may be expressed:

$$ψ ( \% ) = \frac{{N}_{a}}{{N}_{l}} \times 100 \qquad ( 3 )$$

where Nₗ denotes the voxel location capacity and indicates the total number of potential locations at which voxels could be activated within an image space. In the case of display units employing the rotational motion of a screen and employing one or more beam sources for voxel activation, the voxel location capacity is essentially determined by the angular rotation frequency of the surface and the precision of beam deflection. Beam addressed swept volume display units discussed in scientific literature to date have exhibited fill factors of less than 1%. This provides an indication that such systems are unable to depict detailed images (due to their inability to activate large numbers of voxels during the course of an image update frame). Furthermore, such systems are likely to suffer considerably from the voxel displacement problem discussed previously.

An alternative conventional volumetric display unit is described in U.S. Pat. No. 5,162,787 (Thompson et al). Light from a single source (which may be an incandescent, halogen, arc or laser source) is expanded into a collimated beam of light which is directed onto a spatial light modulator (SLM) which may be a deformable mirror device (DMD), Bragg cell or LCD device. The modulated beam is directed onto a rotating single bladed helical screen.

This conventional display suffers from a number of problems. Firstly, image brightness is likely to be undesirably low. Secondly, it is likely to be difficult to switch the SLM sufficiently quickly. Thirdly, the SLM will require a large number of individual modulation elements (e.g. LCD pixels or DMD mirrors) which will make the SLM expensive.

U.S. Pat. No. 4,922,336 discloses a method of displaying a three dimensional image by projecting images from a CRT onto a rotating helix. This device suffers from poor image intensity.

The U.S. Navy have developed a series of three dimensional displays at the Space and Naval Warefare (SPAWAR) Systems Centre in San Diego using scanned lasers. These systems are complex, expensive and cannot activate a large number of voxels due to the limited time available to generate each voxel when utilising a small number of beam sources.

For a more complete summary of the relevant prior art reference is made to “Volumetric Three Dimensional Display Systems” by Barry Blundell and Adam Schwartz published by John Wiley & Sons, Inc, 2000 the disclosure of which is hereby incorporated by reference.

### SUMMARY OF THE INVENTION

It is an object of the invention to overcome at least some of the problems identified in the prior art or to at least provide the public with a useful choice.

According to a first aspect of the invention there is provided a volumetric display unit including a screen, a screen drive for periodically moving said screen; and a plurality of transducers each for converting a respective electric input into a modulated radiation beam which is directed onto said screen.

Preferably an array of laser diodes are arranged to produce beams parallel with the axis of rotation of the screen. A sufficient number of laser diodes may be provided in the array to provide the required resolution in the image space.

The screen is preferably non planar and most preferably a helix. Either a single (one helix) or double (two helices rotationally offset by 180°)bladed helix may be employed or a symmetrical helix (180° of the helix ascends and the other 180° descends in a mirror image) may be used.

The invention can be contrasted with the arrangement in U.S. Pat. No. 5,162,787. In that case, a wide beam of radiation is modulated by an SLM (spacial light modulator). The SLM can be expensive and difficult to efficiently switch quickly. In contrast, the present invention provides a set of individual transducers (such as laser diodes) which each directly convert energy from an electrical signal into a radiation beam (typically in the optical part of the spectrum).

There is further provided a volumetric display unit including a screen; a screen drive for periodically moving said screen; a plurality of beam sources for generating a respective plurality of modulated radiation beams; and a beam drive for periodically moving said beam sources whereby said radiation beams scan over said screen.

By moving a plurality of beam sources using a single common drive registration problems are minimised (compared to scanning systems such as U.S. Pat. No. 5,854,613) and the number of beam sources required is reduced (compared to a static system such as U.S. Pat. No. 5,162,787).

Preferably the screen is non-planar, most preferably helical. The screen may be either single bladed (one helix) or double bladed (two helices rotationally offset by 180°).

The beam sources are mounted on a beam source support which rotates with respect to the screen. The beam source support and the screen may co-rotate or counter rotate, although counter rotation is preferred as this increases the relative rotational speed between the screen and the beam source support. The axes of rotation may be co-axial or offset. Alternatively, the beam source support may exhibit planetary movement with respect to the screen (i.e. rotation of about two axes of rotation).

The beam sources may be laser diodes or non-visible light sources which excite a fluorescent material within or on the screen. In one embodiment of the present invention the sources may take the form of laser diodes which emit visible light. In this case voxels are formed by the scattering of light by the screen. Should the laser diodes emit non-visible light, the screen would be provided with a fluorescent material. Alternatively, the voxel activation subsystem could consist of a plurality of electron beam sources which would give rise to visible voxels by the application of one or more phosphor coatings upon the screen. These are given by way of examples and it should be appreciated that various types of device may constitute the voxel activation subsystem. The beam sources are preferably concentrically arranged and generate beams substantially parallel to the axis of rotation of the screen and to each other.

The passage of signals to the set of beam sources may be achieved by a variety of means. However, the coupling preferably take the form of a highly parallel optical data transfer link as described in the applicant's former PCT application (PCT/NZ99/000072). The passage of power to the beam sources may be achieved through the use of a commutator or by means of other approaches which would be readily apparent to one skilled in the art. The rotational motion of the set of beam sources relative to the screen permits a reduction in the number of beam sources without a significant loss in voxel resolution. Furthermore, since the individual beams are not subjected to angular deflection, problematic registration issues are avoided and the resulting display unit is physically compact. The display unit may exhibit a 100% fill factor (equivalent to exhaustive addressing) and this ensures predictability with respect to voxel placement, avoiding the voxel displacement problem discussed previously.

The beams may propagate onto the screen at an angle to the screen axis of rotation. However, preferably said beam sources are positioned such that said radiation beams propagate onto said screen in a direction substantially parallel to said screen axis of rotation. This makes for a more compact arrangement since the beam sources can be located adjacent to the screen drive.

Similarly, the beam sources may be driven with a translating motion but preferably said beam drive is a rotary drive for rotating said beam sources about a beam axis of rotation, which is typically parallel to the propagation direction of the beams.

The beam sources may be transducers which each generate a respective one of said radiation beams by conversion of a respective electrical input signal. In this case, the transducers themselves are moved by the beam drive.

In an alternative embodiment the beam sources may be formed by the combination of a transducer (such as an incandescent light source or laser) which generates a single wide beam which is modulated by a switchable optic array (such as an SLM of the type described in U.S. Pat. No. 5,162,787). In this case, movement of the beam sources is achieved by moving the switchable optic array.

In a planar screen embodiment, the screen drive may drive the screen in reciprocating, piston-like motion. However, the screen drive is preferably a rotary drive for rotating said screen about a screen axis of rotation.

### BRIEF DESCRIPTION OF THE DRAWINGS

The present invention will now be described by way of example with reference to the accompanying drawings, in which:

FIG. 1 is a schematic side view of a volumetric display unit;

FIG. 2 is a plan view of the beam source support of the unit of FIG. 1.

FIG. 3 is a block diagram of the control and activation systems of a display system incorporating the unit of FIGS. 1 and 2

FIG. 4 is a schematic side view of a volumetric display unit in which the beam sources are moved.

FIG. 5 is a plan view of the beam source support of the unit of FIG. 4.

FIG. 6 is a block diagram of the control and activation systems of the unit of FIGS. 4 and 5.

FIG. 7 is a plan view of a parallel data transmission link of the unit shown in FIGS. 4 to 6.

FIG. 8 is a schematic view of a volumetric display unit according to a further embodiment.

### DESCRIPTION OF THE PREFERRED EMBODIMENTS

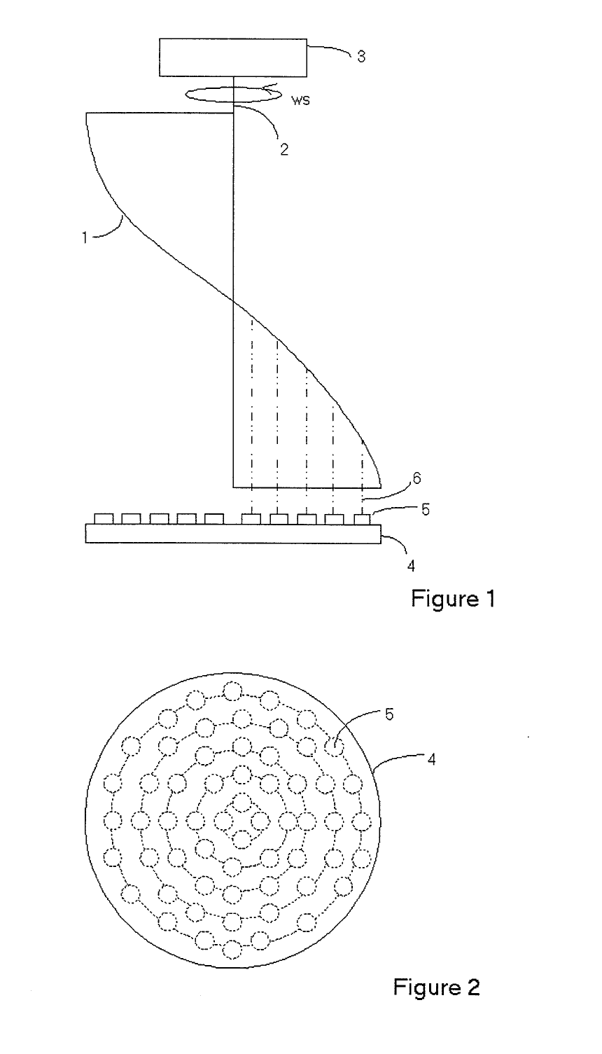

Referring now to FIGS. 1 to 3 a volumetric display unit utilising stationary beam sources will be described. Referring to FIG. 1 the volumetric display unit includes a helical screen 1 rotated about axis 2 at angular velocity ws by screen drive 3 in the form of a motor. A beam source support 4 supports an array of laser diodes 5 (one of which is indicated) which emit visible light. Laser diodes 5 may be modulated so that beams 6 (one of which is indicated) may illuminate the surface of a helix 1 at desired location.

At each point where a beam from a laser diode 5 intersects with the surface of helix 1 a voxel will be generated. It will be appreciated that as helix 1 rotates throughout an entire revolution each laser diode 5 will have the opportunity to address each voxel within a column of the cylindrical image space.

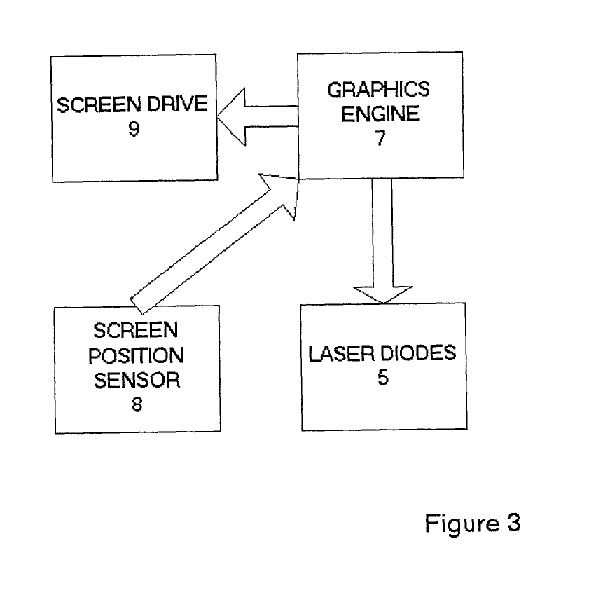

Referring now to FIG. 3 the control and activation circuitry will be described in conjunction with the volumetric display unit shown in FIGS. 1 and 2. Graphics engine 7 detects the position of screen 1 via screen position sensor 8. Graphics engine 7 provides drive signals to laser diodes 5 in dependence upon information from screen position sensor 8. Graphics engine 7 also provides control signals to screen drive 9 to drive motor 3.

It will be appreciated that these figures are illustrative only and that in a practical realisation motor 3 and laser diodes 5 will preferably be provided underneath screen 1 so as not to obstruct the viewable image space. Further, many more laser diodes would be provided in the array, preferably at least three colours to enable colour images to be produced.

Screen 1 is shown as a single bladed 180° helix (i.e. a helix twisted through 180° about its axis of rotation). 90° and 180° or 360° helices may be employed. Further, single or double bladed helices may be utilised. Alternatively, a symmetric helix may be employed.

The laser diodes preferably produce an array of substantially parallel beams. The beams are preferably substantially parallel to the axis of rotation of the helix. The beams could be arranged at angles to the axis of rotation of the helix but this would complicate calculations during image generation and reduce utilisation of the image pace. It is thus preferred that the beam sources generate beams that are substantially parallel to the axis of rotation of the screen.

It will be appreciated that the screen may rotate about a vertical, horizontal or an otherwise inclined axis of rotation. However, it is preferred that the screen rotates about a vertical axis of rotation so that the screen drive and beam sources may be provided below the screen to minimise the screen dead zone and interference with viewing of the image space.

It is envisaged that the array of laser diodes may be manufactured on a single substrate in a semiconductor manufacturing process. In such a case the diameter of the beam source support may be much less than the diameter of the helix 1. In this case an optical arrangement may be utilised to expand the parallel beams generated from the beam source support to produce an array of parallel beams of a diameter corresponding to that of helix 1.

This arrangement is attractive in providing a single stationary unit which produces all beam sources. The screen is a simple rotating helix and no communication links are required between component parts. This arrangement does however require sufficient density of beam sources to ensure that a desired image resolution can be achieved.

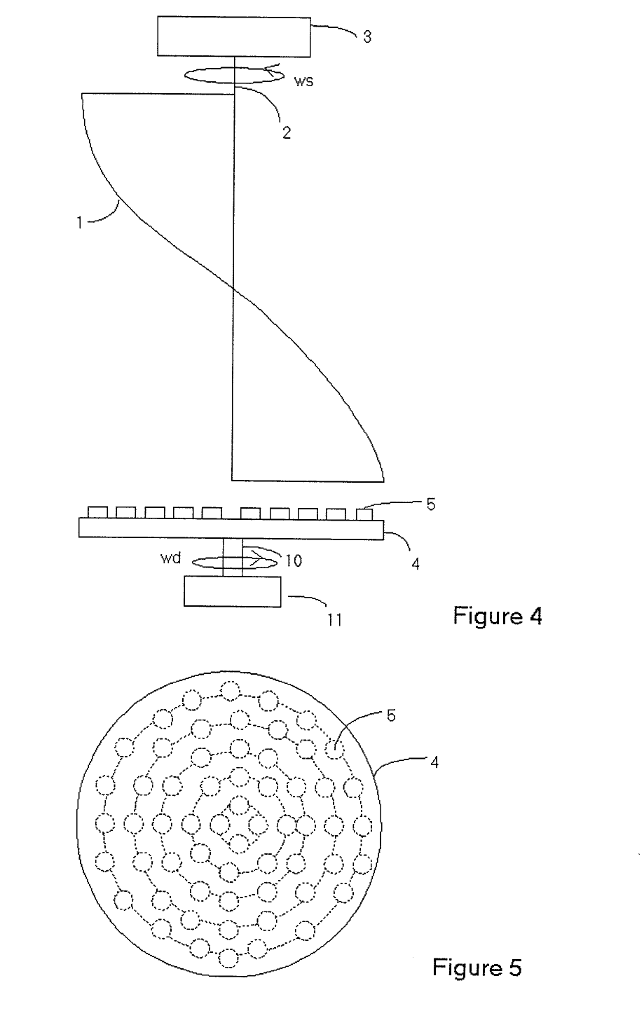

Referring now to FIGS. 4, 5 and 6 an embodiment employing a rotating beam source support will be described. The elements corresponding to those shown in FIGS. 1 and 2 have been given the same numbers. The volumetric display unit of FIGS. 4 and 5 is the same as that shown in the embodiment of FIGS. 1 and 2 except that the beam source support 4 rotates the beam source at angular velocity wd. By rotating beam source support 4 a fewer number of laser diodes 5 can write to a greater number of locations. The number of locations to which a laser diode 5 can write to will be dependent upon the speed of relative rotation between the beam support 4 and screen 1, amongst other factors. Beam support 4 may rotate in the same direction as screen 1 but preferably rotates counter to direction of rotation of screen 1 to maximise the difference in angular velocity and hence the number of locations to which a laser diode 5 can write.

We now consider the relationship between the angular frequency ws of the screen 1 and the angular frequency wd of the disk 4. Consider by way of example a situation in which |wd−ws|=ws. That is, in the case of co-rotation then the frequency of rotation of the disk is twice the frequency of rotation of the screen (fd=2fs), or in the case of counter-rotation the screen and disk rotate at the same frequency in opposite directions. The number of laser diodes 5 within each of the concentric rings may be halved compared to the static situation (or approximately halved as a consequence of the integer number of laser diodes 5 which must be employed). Further increases in the rotational frequency of the disk 4 relative to the screen 1 result in a corresponding reduction in the number of beam sources which must be employed within each concentric ring. Of major significance is the fact that the reduction in the number of beam sources does not result in a corresponding loss of resolution. (In the present invention, resolution is assumed to indicate the minimum distance between nearest neighbour voxels). It is understood by the inventor that in this case the resolution is non homogeneous and anistropic.

As the rate of rotation of the disk is increased relative to the screen, the number of laser diodes contained within each concentric ring may be reduced. From this we conclude that it is desirable to maximise |wd−ws|. Consequently, it is desirable that the disk rotates in a direction which is opposite to the direction of rotation of the screen. Although this is the preferred alternative, the present disclosure encompasses both co-rotation and counter rotation. Ideally, wd is an integer multiple of ws.

The approximate number of voxels required for a simple display is calculated below. Where the voxel spacing along a track is “a” and spacing between tracks is “b” the number of sources required for a track of radius r/2 (to average track length) is given as follows:

$$average number of sources per track = \frac{2 π r}{2} \div a = \frac{π r}{a}$$

$$the number of tracks = \frac{r}{b}$$

$$the total number of sources N = \frac{π r}{a} \times \frac{r}{b} = \frac{π {r}^{2}}{ab}$$

thus, for a helix radius 20 cm the number of beam sources N is as follows (using 3 as an approximate to π)

$$N = \frac{1200}{ab}$$

assuming a=2 mm and b=2 mm then the approximate number of beam sources N is as follows:

N=1200÷0.04=30000

This is a relatively minimal implementation and preferably many more beam sources would be provided to give high image resolution.

When the helix rotates at 25 Hz and the disk rotates in the opposite direction at 25 Hz the difference in rotational frequency is 2Wₕ.This results in a reduction of N to about 15,000.

At 10Wₕ N reduces to about 3,000. However, if the number of sources is reduced each source must work harder. Assuming an image space height of 20 cm and vertical voxel separation of 2 mm the maximum number of voxels vertically is 20÷0.2=100. At 10Wₕ the total number of voxel locations within the volume=3000×100=3 million. With 3,000 sources each must create about:

3×10⁶÷3×10³=1000 voxels per frame

Allowing a maximum 2 mm distortion of each voxel this would require a beam source having a maximum dwell time of 3 micro seconds (at 10Wₕ).

In the embodiment of FIG. 4 the beam source support 4 and screen 1 rotate about a common axis. The axes of rotation of the beam support surface and screen 1 may be offset so that each laser diode 5 addresses a series of ellipses on screen and preferably the ratio of |wd/ws | s a non-integer quantity. Alternatively, beam source support 4 may exhibit planetary motion (rotation about two centres of rotation) so that each laser diode may write to an even greater number of locations by tracing the pattern of a Lissajous figure.

Although laser diodes are shown in this and the previous embodiment it is to be appreciated that the beam sources may be any of a range of transducers which generate radiation in accordance with electronic signals supplied thereto. Non-visible laser diodes may be employed where a fluorescent material is provided in or on the surface of helix 1. Alternatively, electron beam sources may be utilised in conjunction with fluorescent materials provided in or on screen 1 with the components housed within a transparent evacuated vessel.

The beam sources are preferably arranged in concentric rings. The number required decreases as the relative angular velocity between the screen and beam source support increases.

The beams generated by the beam sources are preferably parallel to each other and parallel to the axis of rotation of the screen. The screen is preferably a helix although other non-planar surfaces can be employed (see the screen utilised in U.S. Pat. No. 3,204,238 for example).

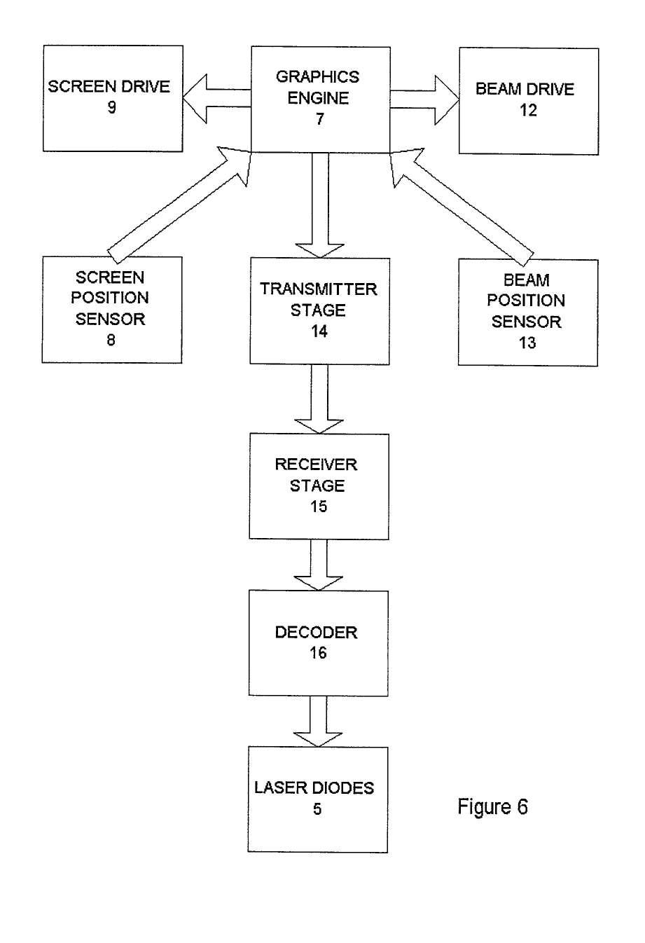

Referring now to FIG. 6 the controller activation circuitry utilised to drive the display unit in FIGS. 4 and 5 is shown. Sections 7, 8 and 9 are as per FIG. 3. In this case, however, graphics engine 7 must also drive beam drive 12 which drives motor 11, which rotates beam source support 4 via shaft 10. Beam position sensor 13 provides information regarding the position of beam source support 4. Position sensors 8 and 13 may be any of a range of optical, Hall effect sensors etc well known to those skilled in the art. Based on information from screen position sensor 8 as to the position of screen 1 and beam position sensor 13 as to the position of beam source support 4 graphics engine 7 determines activation of laser diodes 5. Activation information is sent to optical transmitter 14 which transmits information via an optical link to receiver stage 15. This information is received by decoder 16 and the appropriate laser diodes 5 are driven.

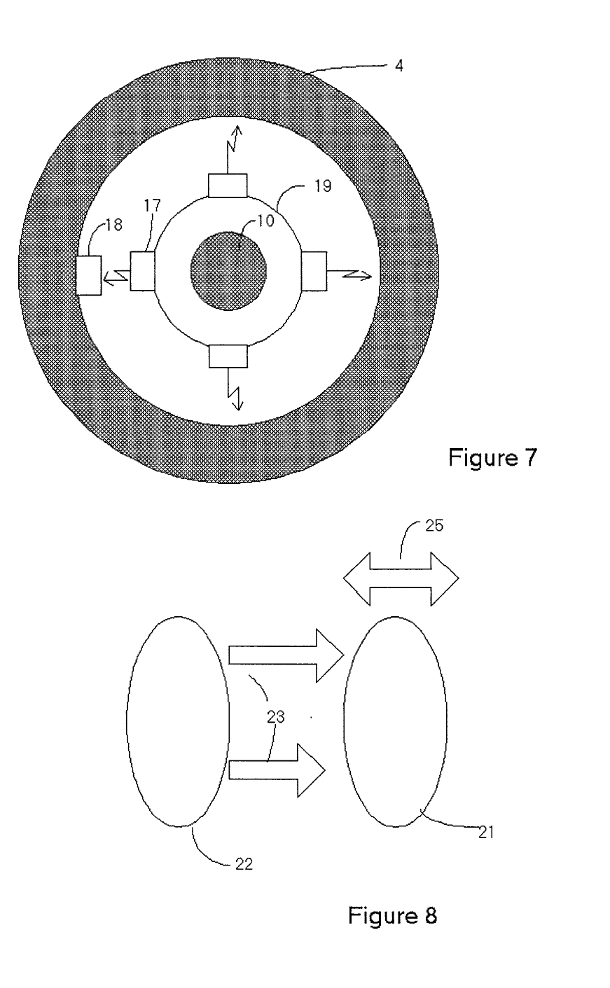

Referring now to FIG. 7 an optical link for transmitting data from the graphics engine to the rotating beam source support 4 is shown. Shaft 10 rotates within stationary sleeve 19. Upon sleeve 19 are provided a plurality of optical emitters 17 (one of which is shown) which transmit signals received from transmitter stage 14. Optical receiver 18 receives optical information transmitted by the optical transmitters 17 and supplies the received data to receiver stage 15.

It will be appreciated that several such transmitter and receiver arrangements may be provided along sleeve 18 to provide a plurality of parallel optical data paths if required. The optical data transfer link may take the form described in the applicant's former PCT application (PCT/NZ99/000072), the disclosure of which is hereby included by reference. Power may be supplied to the beam source support 4 via a conventional commutator, induction or other link.

This arrangement has the advantage that the number of beam sources may be reduced while 100% fill factor can be achieved. Registration problems are substantially eliminated due to the fixed relationships of the components. This configuration is also highly desirable due to the high degree of parallelism of the system.

In any particular application the particular operating parameters will be a balance between voxel resolution, the relative angular velocity between the screen and the beam source support, the number of sources, the power of the sources, the required image intensity, the image spaced dimensions, and the possible switching speeds of the beam sources.

According to another embodiment the beam source support 4 and beam sources 5 may be replaced by a rotatable mask. The mask could be in the form of a plurality of switchable optical arrays which may selectively allow the transmission of light. A wide collimated beam may be provided underneath the mask and the switchable optical array may be driven to selectively permit the transmission of light through the optical array onto the helix. Given the relatively low dwell times allowed this approach may be difficult to achieve utilising currently available technologies. LCD arrays for example may be too slow to achieve satisfactory results. Another approach would be to adapt the device disclosed in U.S. Pat. No. 5,162,787 so that the spacial light modulator (SLM) is rotated or translated to reduce the number of elements required.

In a further alternative embodiment shown in FIG. 8 the rotating helical screen is replaced by circular panel 21 which is reciprocated as indicated by arrow 25 in order to sweep out a cylindrical space. Disc 22 is of the form shown in FIG. 2 and is rotated about its axis of rotation to project beams 23 onto panel 21 as it reciprocates.

Where in the foregoing description reference has been made to integers or components having known equivalents then such equivalents are herein incorporated as if individually set forth.

Although this invention has been described by way of example it is to be appreciated that improvements and/or modifications may be made thereto without departing from the scope or spirit of the present invention.

I claim:

1. A volumetric display unit including a screen; a screen drive for periodically moving said screen; a plurality of beam sources for generating a respective plurality of modulated radiation beams; and a beam drive for periodically moving said beam sources whereby said radiation beams scan over said screen.

2. A display unit according to claim 1 wherein said screen is non-planar.

3. A display unit according to claim 2 wherein said screen is in the form of a helix.

4. A display unit according to claim 1 wherein said screen drive is a rotary drive for rotating said screen about a screen axis of rotation.

5. A display unit according to claim 4 wherein said beam sources are positioned such that said radiation beams propagate onto said screen in a direction substantially parallel to said screen axis of rotation.

6. A display unit according to claim 1 wherein said beam drive is a rotary drive for rotating said beam sources about a beam axis of rotation.

7. A display unit according to claim 6 wherein said beam axis of rotation is substantially parallel with a direction of propagation of said beams.

8. A display unit according to claim 6 wherein said screen drive is a rotary drive for rotating said screen about a screen axis of rotation, and wherein said beam axis of rotation is offset from said screen axis of rotation.

9. A display unit according to claim 6 wherein said screen drive is a rotary drive for rotating said screen about a screen axis of rotation, and wherein said beam drive is adapted to rotate said beam sources in an opposite direction to a direction of rotation of said screen.

10. A display unit according to claim 1 further including a data transmission link for feeding data to drive said beam sources, said link comprising a plurality of radiation transmitters for transmitting data received from a graphics engine; and a plurality of radiation receivers moving with said beam sources for receiving radiation from said transmitters and outputting signals to said beam sources.

11. A display unit according to claim 1 wherein said beam sources are transducers which each generate a respective one of said radiation beams by conversion of a respective electrical input signal.

12. A display unit according to claim 11 wherein said beam sources are laser diodes.

13. A display unit according to claim 1 wherein said radiation beams are substantially parallel with each other at the point at which they impinge onto said screen.

14. A display unit according to claim 1 further including a beam source support which carries said beam sources, wherein said beam drive is coupled to said beam source support.

15. A method of addressing a screen in a volumetric display unit, the method including the steps of periodically moving the screen; generating a plurality of modulated radiation beams with a plurality of beam sources; and periodically moving said beam sources whereby said radiation beams scan over said screen.

16. A method according to claim 15 wherein said screen is moved by rotating said screen about a screen axis of rotation.

17. A method according to claim 15 wherein said beam sources are moved by rotating said beam sources about a beam axis of rotation.

18. A method according to claim 17 wherein said screen is moved by rotating said screen about a screen axis of rotation which is offset from said beam axis of rotation.

19. A method according to claim 17 wherein said screen is moved by rotating said screen about a screen axis of rotation, and wherein said beam sources are rotated in an opposite direction to a direction of rotation of said screen.

20. A volumetric display unit including a screen; a screen drive for periodically moving said screen; and a plurality of transducers each for converting a respective electrical input into a modulated radiation beam which is directed onto said screen.

21. A display unit according to claim 20 wherein said screen is non-planar.

22. A display unit according to claim 21 wherein said screen is in the form of a helix.

23. A display unit according to claim 20 wherein said screen drive is a rotary drive for rotating said screen about a screen axis of rotation.

24. A display unit according to claim 23 wherein said transducers are positioned such that said beams propagate onto said screen in a direction substantially parallel to said screen axis of rotation.

25. A display unit according to claim 20 further including a beam drive for periodically moving said transducers whereby said radiation beams scan over said screen.

26. A display unit according to claim 25 further including a support which carries said transducers, wherein said beam drive is coupled to said support.

27. A display unit according to claim 25 wherein said beam drive is a rotary drive for rotating said transducers about a beam axis of rotation.

28. A display unit according to claim 27 wherein said beam axis of rotation is substantially perpendicular to a direction of propagation of said beams.

29. A display unit according to claim 27 wherein said screen drive is a rotary drive for rotating said screen about a screen axis of rotation, and wherein said beam axis of rotation is offset from said screen axis of rotation.

30. A display unit according to claim 27 wherein said screen drive is a rotary drive for rotating said screen about a screen axis of rotation, and wherein said beam drive is adapted to rotate said transducers in an opposite direction to a direction of rotation of said screen.

31. A display unit according to claim 20 wherein said transducers are laser diodes.

32. A display unit according to claim 20 wherein said radiation beams are substantially parallel with each other at the point at which they impinge onto said screen.

33. A display unit according to claim 20 further including a data transmission link for feeding data to said transducers, said link comprising a set of radiation transmitters for transmitting data received from a graphics engine; and a set of radiation receivers for receiving radiation from said transmitters and outputting signals to said transducers.

34. A method of addressing a screen in a volumetric display unit, the method including the steps of periodically moving said screen;
converting a plurality of electrical inputs into a plurality of modulated radiation beams using a respective plurality of transducers; and directing said radiation beams onto said screen.

35. A method according to claim 34 wherein said screen is moved by rotating said screen about a screen axis of rotation.

36. A method according to claim 34 further including the step of periodically moving said transducers whereby said radiation beams scan over said screen.

37. A method according to claim 36 wherein said transducers are moved by rotating said transducers about a beam axis of rotation.

38. A method according to claim 37 wherein said screen is moved by rotating said screen about a screen axis of rotation which is offset from said beam axis of rotation.

39. A method according to claim 37 wherein said screen is moved by rotating said screen about a screen axis of rotation, and wherein said beam sources are rotated in an opposite direction to a direction of rotation of said screen.
